(19) United States
(12) Patent Application Publication
(10) Pub. No.: US 2007/0298317 A1
(43) Pub. Date: Dec. 27, 2007

(54) SECONDARY ELECTROCHEMICAL CELL WITH INCREASED CURRENT COLLECTING EFFICIENCY

(76) Inventors: Ralph Brodd, Henderson, NV (US); Robert Hyland, Tucscon, AZ (US); James Akridge, Tucscon, AZ (US)

Correspondence Address: VALENCE TECHNOLOGY, INC., 1889 E. MAULE AVENUE, SUITE A, LAS VEGAS, NV, 89119, US

(21) Appl. No.: 11/746,142

(22) Filed: May 9, 2007

Related U.S. Application Data
(60) Provisional application No. 60/746,795, filed on May 9, 2006.

(51) Int. Cl. H01M 6/10

(52) U.S. Cl. 429/94

(57) ABSTRACT

The invention provides a cylindrical electrochemical cell which includes a first electrode and a second electrode which is a counter electrode to the first electrode, and an electrolyte. The first electrode includes a polyanion-based electrode active material.

This Application claims the benefit of Provisional Application Ser. No. 60/746,795 filed May 9, 2006.

### FIELD OF THE INVENTION

This invention relates to electrochemical cells employing a non-aqueous electrolyte and a polyanion-based electrode active material, wherein the cells are characterized as having increased current collecting efficiency.

### BACKGROUND OF THE INVENTION

A battery consists of one or more electrochemical cells, wherein each cell typically includes a positive electrode, a negative electrode, and an electrolyte or other material for facilitating movement of ionic charge carriers between the negative electrode and positive electrode. As the cell is charged, cations migrate from the positive electrode to the electrolyte and, concurrently, from the electrolyte to the negative electrode. During discharge, cations migrate from the negative electrode to the electrolyte and, concurrently, from the electrolyte to the positive electrode.

Such batteries generally include an electrochemically active material having a crystal lattice structure or framework from which ions can be extracted and subsequently reinserted, and/or permit ions to be inserted or intercalated and subsequently extracted.

Recently, three-dimensionally structured compounds comprising polyanions (e.g., (SO₄)ⁿ⁻, (PO₄)ⁿ⁻, (AsO₄)ⁿ⁻, and the like), have been devised as viable alternatives to oxide-based electrode materials such as LiMₓO_{y}, wherein M is a transition metal such as cobalt (Co). These polyanion-based compounds have exhibited some promise as electrode components, and are especially suited for high rate applications. However, prior attempts to implement these polyanion-based compounds in high rate secondary electrochemical cells has proven substantially unsuccessful. Therefore, there is a current need for a secondary electrochemical cell which, when a polyanion-based electrode active material is employed, is capable of withstanding high rate cycling.

### SUMMARY OF THE INVENTION

The present invention provides a novel secondary electrochemical cell having an electrode active material represented by the nominal general formula:
AₐMₘ(XY₄)_{c}Zₑ,

wherein:
(i) A is selected from the group consisting of elements from Group I of the Periodic Table, and mixtures thereof, and 0<a≦9;
(ii) M includes at least one redox active element, and 1≦m≦3;
(iii) XY₄ is selected from the group consisting of X′[O₄₋ₓ,Y′ₓ], X′[O_{4-y}, Y′_{2y}], X″S₄, [X_{z}′″,X′_{1-z}]O₄, and mixtures thereof, wherein:
   (a) X′ and X′″ are each independently selected from the group consisting of P, As, Sb, Si, Ge, V, S, and mixtures thereof;
   (b) X″ is selected from the group consisting of P, As, Sb, Si, Ge, V, and mixtures thereof;
   (c) Y′ is selected from the group consisting of a halogen, S, N, and mixtures thereof; and
   (d) 0≦x≦3, 0≦y≦2, 0≦z≦1, and 1<c≦3; and
(iv) Z is selected from the group consisting of a hydroxyl (OH), a halogen selected from Group 17 of the Periodic Table, and mixtures thereof, and 0≦e≦4;

wherein A, M, X, Y, Z, a, m, c, x, y, z, and e are selected so as to maintain electroneutrality of the material in its nascent or as-synthesized state.

In one embodiment, the secondary electrochemical cell is a cylindrical cell having a spirally coiled or wound electrode assembly enclosed in a cylindrical casing. In an alternate embodiment, the secondary electrochemical cell is a prismatic cell having a jellyroll-type electrode assembly enclosed in a cylindrical casing having a substantially rectangular cross-section.

In each embodiment described herein, the electrode assembly includes a separator interposed between a first electrode (positive electrode) and a counter second electrode (negative electrode), for electrically insulating the first electrode from the second electrode. An electrolyte (preferably a non-aqueous electrolyte) is provided for transferring ionic charge carriers between the first electrode and the second electrode during charge and discharge of the electrochemical cell.

The first and second electrodes each include an electrically conductive current collector for providing electrical communication between the electrodes and an external load. An electrode film is formed on at least one side of each current collector, preferably both sides of the positive electrode current collector, in a manner so as to provide an uncoated or exposed edge portion of the current collector free from electrode film, which extends from a long edge of each electrode. Each electrode is positioned relative to the separator, whereby when the electrode assembly is wound or rolled-up, the exposed portions of each electrode project outward beyond the separator at opposing ends of the coiled or wound electrode assembly.

A first electrode plate contacts the exposed portion of the first electrode current collector in order to provide electrical communication between the first electrode current collector and an external load. An opposing second electrode plate contacts the exposed portion of the second electrode current collector in order to provide electrical communication between the second electrode current collector and an external load.

### BRIEF DESCRIPTION OF THE DRAWINGS

FIG. 1 is a schematic cross-sectional diagram illustrating the structure of a non-aqueous electrolyte cylindrical electrochemical cell of the present invention.

FIG. 2 is a perspective view of the electrode assembly and electrode plates.

FIG. 3 is another perspective view of the electrode assembly.

FIG. 4 is a perspective view of an electrode plate.

FIG. 5 is a cross-sectional diagram illustrating an electrode plate having an angled edge.

FIG. 6 is a perspective view of another embodiment of an electrode plate.

FIG. 7 is a top view of another embodiment of an electrode plate.

FIG. 8 is a perspective view of another embodiment of an electrode plate.

FIG. 9 is a top and sectional view of another embodiment of an electrode plate.

FIG. 10 is a cross-sectional diagram illustrating the structure of an electrode plate and electrode assembly.

FIG. 11 is a cross-sectional diagram illustrating another structure of a non-aqueous electrolyte cylindrical electrochemical cell of the present invention.

### DETAILED DESCRIPTION OF THE PREFERRED EMBODIMENTS

It has been found that the novel electrochemical cells of this invention afford benefits over such materials and devices among those known in the art. Such benefits include, without limitation, one or more of reduced internal cell resistance, enhanced cycling capability, enhanced reversibility, enhanced current collection efficiency, enhanced electrical conductivity, and reduced costs. Specific benefits and embodiments of the present invention are apparent from the detailed description set forth herein below It should be understood, however, that the detailed description and specific examples, while indicating embodiments among those preferred, are intended for purposes of illustration only and are not intended to limit the scope of the invention.

The present invention provides a electricity-producing electrochemical cell having an electrode active material represented by the nominal general formula (I):
AₐMₘ(XY₄)_{c}Zₑ. (I)

The term “nominal general formula” refers to the fact that the relative proportion of atomic species may vary slightly on the order of 2 percent to 5 percent, or more typically, 1 percent to 3 percent. The composition of A, M, XY₄ and Z of general formula (I), as well as the stoichiometric values of the elements of the active material, are selected so as to maintain electroneutrality of the electrode active material. The stoichiometric values of one or more elements of the composition may take on non-integer values.

For all embodiments described herein, A is selected from the group consisting of elements from Group I of the Periodic Table, and mixtures thereof (e.g. Aₐ=A_{a-a′}A′_{a′}, wherein A and A′ are each selected from the group consisting of elements from Group I of the Periodic Table and are different from one another, and a′<a). As referred to herein, “Group” refers to the Group numbers (i.e., columns) of the Periodic Table as defined in the current IUPAC Periodic Table. (See, e.g., U.S. Pat. No. 6,136,472, Barker et al., issued Oct. 24, 2000, incorporated by reference herein.) In addition, the recitation of a genus of elements, materials or other components, from which an individual component or mixture of components can be selected, is intended to include all possible sub-generic combinations of the listed components, and mixtures thereof.

In one embodiment, A is selected from the group consisting of Li (Lithium), Na (Sodium), K (Potassium), and mixtures thereof. A may be mixture of Li with Na, a mixture of Li with K, or a mixture of Li, Na and K. In another embodiment, A is Na, or a mixture of Na with K. In one preferred embodiment, A is Li.

A sufficient quantity (a) of moiety A should be present so as to allow all of the “redox active” elements of moiety M (as defined herein below) to undergo oxidation/reduction. In one embodiment, 0<a≦9. In another embodiment, 3≦a≦5. In another embodiment, 3<a≦5. Unless otherwise specified, a variable described herein algebraically as equal to (“=”), less than or equal to (“≦”), or greater than or equal to (“≧”) a number is intended to subsume values or ranges of values about equal or functionally equivalent to said number.

Removal of an amount of A from the electrode active material is accompanied by a change in oxidation state of at least one of the “redox active” elements in the active material, as defined herein below. The amount of redox active material available for oxidation/reduction in the active material determines the amount (a) of the moiety A that may be removed. Such concepts are, in general application, well known in the art, e.g., as disclosed in U.S. Pat. No. 4,477,541, Fraioli, issued Oct. 16, 1984; and U.S. Pat. No. 6,136,472, Barker, et al., issued Oct. 24, 2000, both of which are incorporated by reference herein.

In general, the amount (a) of moiety A in the active material varies during charge/discharge. Where the active materials of the present invention are synthesized for use in preparing an alkali metal-ion battery in a discharged state, such active materials are characterized by a relatively high value of “a”, with a correspondingly low oxidation state of the redox active components of the active material. As the electrochemical cell is charged from its initial uncharged state, an amount (b) of moiety A is removed from the active material as described above. The resulting structure, containing less amount of the moiety A (i.e., a-b) than in the as-prepared state, and at least one of the redox active components having a higher oxidation state than in the as-prepared state, while essentially maintaining the original stoichiometric values of the remaining components (e.g. M, X, Y and Z). The active materials of this invention include such materials in their nascent state (i.e., as manufactured prior to inclusion in an electrode) and materials formed during operation of the battery (i.e., by insertion or removal of A).

For all embodiments described herein, moiety A may be partially substituted by moiety D by aliovalent or isocharge substitution, in equal or unequal stoichiometric amounts, wherein:
Aₐ=[A_{a-(f/V}^{A}₎,D_{(d/V}^{D}₎], (a)

(b) V^{A} is the oxidation state of moiety A (or sum of oxidation states of the elements consisting of the moiety A), and V^{D} is the oxidation state of moiety D;
V^{A}=V^{D} or V^{A}≠V^{D}; (c)
f=d or f≠d; and (d)
f,d>0 and d≦f≦a.

“Isocharge substitution” refers to a substitution of one element on a given crystallographic site with an element having the same oxidation state (e.g. substitution of Ca²⁺ with Mg²⁺). “Aliovalent substitution” refers to a substitution of one element on a given crystallographic site with an element of a different oxidation state (e.g. substitution of Li⁺ with Mg²⁺).

Moiety D is at least one element preferably having an atomic radius substantially comparable to that of the moiety being substituted (e.g. moiety M and/or moiety A). In one embodiment, D is at least one transition metal Examples of transition metals useful herein with respect to moiety D include, without limitation, Nb (Niobium), Zr (Zirconium), Ti (Titanium), Ta (Tantalum), Mo (Molybdenum), W (Tungsten), and mixtures thereof. In another embodiment, moiety D is at least one element characterized as having a valence state of ≧2+ and an atomic radius that is substantially comparable to that of the moiety being substituted (e.g. M and/or A). With respect to moiety A, examples of such elements include, without limitation, Nb (Niobium), Mg (Magnesium) and Zr (Zirconium). Preferably, the valence or oxidation state of D (V^{D}) is greater than the valence or oxidation state of the moiety (or sum of oxidation states of the elements consisting of the moiety) being substituted for by moiety D (e.g. moiety M and/or moiety A).

For all embodiments described herein where moiety A is partially substituted by moiety D by isocharge substitution, A may be substituted by an equal stoichiometric amount of moiety D, wherein f,d>0, f≦a, and f=d.

Where moiety A is partially substituted by moiety D by isocharge substitution and d≠f, then the stoichiometric amount of one or more of the other components (e.g. A, M, XY₄ and Z) in the active material must be adjusted in order to maintain electroneutrality.

For all embodiments described herein where moiety A is partially substituted by moiety D by aliovalent substitution, moiety A may be substituted by an “oxidatively” equivalent amount of moiety D, wherein: f=d; f,d<0; and f≦a.

Where moiety is partially substituted by moiety D by aliovalent substitution and d≠f, then the stoichiometric amount of one or more of the other components (e.g. A, M, XY₄ and Z) in the active material must be adjusted in order to maintain electroneutrality.

Referring again to general formula (I), in all embodiments described herein, moiety M is at least one redox active element. As used herein, the term “redox active element” includes those elements characterized as being capable of undergoing oxidation/reduction to another oxidation state when the electrochemical cell is operating under normal operating conditions. As used herein, the term “normal operating conditions” refers to the intended voltage at which the cell is charged, which, in turn, depends on the materials used to construct the cell.

Redox active elements useful herein with respect to moiety M include, without limitation, elements from Groups 4 through 11 of the Periodic Table, as well as select non-transition metals, including, without limitation, Ti (Titanium), V (Vanadium), Cr (Chromium), Mn (Manganese), Fe (Iron), Co (Cobalt), Ni (Nickel), Cu (Copper), Nb (Niobium), Mo (Molybdenum), Ru (Ruthenium), Rh (Rhodium), Pd (Palladium), Os (Osmium), Ir (iridium), Pt (Platinum), Au (Gold), Si (Silicon), Sn (Tin), Pb (Lead), and mixtures thereof. For each embodiment described herein, M may comprise a mixture of oxidation states for the selected element (e.g., M=Mn²⁺Mn⁴⁺). Also, “include,” and its variants, is intended to be non-limiting, such that recitation of items in a list is not to the exclusion of other like items that may also be useful in the materials, compositions, devices, and methods of this invention.

In one embodiment, moiety M is a redox active element. In one subembodiment, M is a redox active element selected from the group consisting of Ti²⁺, V²⁺, Cr²⁺, Mn²⁺, Fe²⁺, Co²⁺, Ni²⁺, Cu²⁺, Mo²⁺, Si²⁺, and Pb²⁺. In another subembodiment, M is a redox active element selected from the group consisting of Ti³⁺, V³⁺, Cr³⁺, Mn³⁺, Fe³⁺, Co³⁺, Ni³⁺, Mo³⁺, and Nb³⁺.

In another embodiment, moiety M includes one or more redox active elements and (optionally) one or more non-redox active elements. As referred to herein, “non-redox active elements” include elements that are capable of forming stable active materials, and do not undergo oxidation/reduction when the electrode active material is operating under normal operating conditions.

Among the non-redox active elements useful herein include, without limitation, those selected from Group 2 elements, particularly Be (Beryllium), Mg (Magnesium), Ca (Calcium), Sr (Strontium), Ba (Barium); Group 3 elements, particularly Sc (Scandium), Y (Yttrium), and the lanthanides, particularly La (Lanthanum), Ce (Cerium), Pr (Praseodymium), Nd (Neodymium), Sm (Samarium); Group 12 elements, particularly Zn (Zinc) and Cd (Cadmium); Group 13 elements, particularly B (Boron), Al (Aluminum), Ga (Gallium), In (Indium), TI (Thallium); Group 14 elements, particularly C (Carbon) and Ge (Germanium), Group 15 elements, particularly As (Arsenic), Sb (Antimony), and Bi (Bismuth); Group 16 elements, particularly Te (Tellurium); and mixtures thereof.

In one embodiment, M=MIₙMIIₒ, wherein 0<o+n≦3 and each of o and n is greater than zero (0<o,n), wherein MI and MII are each independently selected from the group consisting of redox active elements and non-redox active elements, wherein at least one of MI and MII is redox active. MI may be partially substituted with MII by isocharge or aliovalent substitution, in equal or unequal stoichiometric amounts.

For all embodiments described herein where MI is partially substituted by MII by isocharge substitution, MI may be substituted by an equal stoichiometric amount of MII, whereby M=MIₙ₋ₒMIIₒ. Where MI is partially substituted by MII by isocharge substitution and the stoichiometric amount of MI is not equal to the amount of MII, whereby M=MIₙ₋ₒMIIₚ and o≠p, then the stoichiometric amount of one or more of the other components (e.g. A, D, XY₄ and Z) in the active material must be adjusted in order to maintain electroneutrality.

For all embodiments described herein where MI is partially substituted by MII by aliovalent substitution and an equal amount of MI is substituted by an equal amount of MII, whereby M=MIₙ₋ₒMIIₒ, then the stoichiometric amount of one or more of the other components (e.g. A, D, XY₄ and Z) in the active material must be adjusted in order to maintain electroneutrality. However, MI may be partially substituted by MII by aliovalent substitution by substituting an “oxidatively” equivalent amount of MII for MI, whereby

$$M = {MI}_{n - \frac{o}{{V}^{MI}}} {MII}_{\frac{o}{{V}^{MII}}} ,$$

wherein V^{MI} is the oxidation state of MI, and V^{MII} is the oxidation state of MII.

In one subembodiment, MI is selected from the group consisting of Ti, V, Cr, Mn, Fe, Co, Ni, Cu, Mo, Si, Pb, Mo, Nb, and mixtures thereof, and MII is selected from the group consisting of Be, Mg, Ca, Sr, Ba, Sc, Y, Zn, Cd, B, Al, Ga, In, C, Ge, and mixtures thereof. In this subembodiment, MI may be substituted by MII by isocharge substitution or aliovalent substitution.

In another subembodiment, MI is partially substituted by MII by isocharge substitution. In one aspect of this subembodiment, MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of Be²⁺, Mg²⁺, Ca²⁺, Sr²⁺, Ba²⁺, Zn²⁺, Cd²⁺, Ge²⁺, and mixtures thereof. In another aspect of this subembodiment, MI is selected from the group specified immediately above, and MII is selected from the group consisting of Be²⁺, Mg²⁺, Ca²⁺, Sr²⁺, Ba²⁺, and mixtures thereof. In another aspect of this subembodiment, MI is selected from the group specified above, and MII is selected from the group consisting of Zn²⁺, Cd²⁺ and mixtures thereof. In yet another aspect of this subembodiment, MI is selected from the group consisting of Ti³⁺, V³⁺, Cr³⁺, Mn³⁺, Fe³⁺, Co³⁺, Ni³⁺, Mo³⁺, Nb³⁺, and mixtures thereof, and MII is selected from the group consisting of Sc³⁺, Y³⁺, B³⁺, Al³⁺, Ga³⁺, In³⁺, and mixtures thereof.

In another embodiment, MI is partially substituted by MII by aliovalent substitution. In one aspect of this subembodiment, MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of Sc³⁺, Y³⁺, B³⁺, Al³⁺, Ga³⁺, In³⁺, and mixtures thereof. In another aspect of this subembodiment, MI is a 2+ oxidation state redox active element selected from the group specified immediately above, and MII is selected from the group consisting of alkali metals, Cu¹⁺, Ag¹⁺ and mixtures thereof. In another aspect of this subembodiment, MI is selected from the group consisting of Ti³⁺, V³⁺, Cr³⁺, Mn³⁺, Fe³⁺, Co³⁺, Ni³⁺, Mo³⁺, Nb³⁺, and mixtures thereof, and MII is selected from the group consisting of Be²⁺, Mg²⁺, Ca²⁺, Sr²⁺, Ba²⁺, Zn²⁺, Cd²⁺, Ge²⁺, and mixtures thereof. In another aspect of this subembodiment, MI is a 3+ oxidation state redox active element selected from the group specified immediately above, and MII is selected from the group consisting of alkali metals, Cu¹⁺, Ag¹⁺ and mixtures thereof.

In another embodiment, M=M1_{q}M2ᵣM3ₛ, wherein:
(i) M1 is a redox active element with a 2+ oxidation state;
(ii) M2 is selected from the group consisting of redox and non-redox active elements with a 1+ oxidation state;
(iii) M3 is selected from the group consisting of redox and non-redox active elements with a 3+ or greater oxidation state; and
(iv) at least one of q, r and s is greater than 0, and at least one of M1, M2, and M3 is redox active.

In one subembodiment, M1 is substituted by an equal amount of M2 and/or M3, whereby q=q−(r+s). In this subembodiment, then the stoichiometric amount of one or more of the other components (e.g. A, XY₄, Z) in the active material must be adjusted in order to maintain electroneutrality.

In another subembodiment, M¹ is substituted by an “oxidatively” equivalent amount of M² and/or M³, whereby

$$M = M {1}_{q - \frac{r}{{V}^{M 1}} - \frac{s}{{V}^{M 1}}} M {2}_{\frac{r}{{V}^{M 2}}} M {3}_{\frac{s}{{V}^{M 3}} ,}$$

wherein V^{M1} is the oxidation state of M1, V^{M2} is the oxidation state of M2, and V^{M3} is the oxidation state of M3.

In one subembodiment, M1 is selected from the group consisting of Ti²⁺, V²⁺, C²⁺, Mn²⁺, Fe²⁺, Co²⁺, Ni²⁺, Cu²⁺, Mo²⁺, Si²⁺, Sn²⁺, Pb²⁺, and mixtures thereof; M2 is selected from the group consisting of Cu¹⁺, Ag¹⁺ and mixtures thereof; and M3 is selected from the group consisting of Ti³⁺, V³⁺, Cr³⁺, Mn³⁺, Fe³⁺, Co³⁺, Ni³⁺, Mo³⁺, Nb³⁺, and mixtures thereof. In another subembodiment, M1 and M3 are selected from their respective preceding groups, and M2 is selected from the group consisting of Li¹⁺, Ki⁺, Na¹⁺, Ru¹⁺, Cs¹⁺, and mixtures thereof.

In another subembodiment, M1 is selected from the group consisting of Be²⁺, Mg²⁺, Ca²⁺, Sr²⁺, Ba²⁺, Zn²⁺, Cd²⁺, Ge²⁺, and mixtures thereof; M2 is selected from the group consisting of Cu¹⁺, Ag¹⁺ and mixtures thereof; and M3 is selected from the group consisting of Ti³⁺, V³⁺, Cr³⁺, Mn³⁺, Fe³⁺, Co³⁺, Ni³⁺, Mo³⁺, Nb³⁺, and mixtures thereof. In another subembodiment, M1 and M3 are selected from their respective preceding groups, and M2 is selected from the group consisting of Li¹⁺, K¹⁺, Na¹⁺, Ru¹⁺, Cs¹⁺, and mixtures thereof.

In another subembodiment, M1 is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof; M2 is selected from the group consisting of Cu¹⁺, Ag¹⁺, and mixtures thereof; and M3 is selected from the group consisting of Sc³⁺, Y³⁺, B³⁺, Al³⁺, Ga³⁺, In³⁺, and mixtures thereof. In another subembodiment, M1 and M3 are selected from their respective preceding groups, and M2 is selected from the group consisting of Li¹⁺, K¹⁺, Na¹⁺, Ru¹⁺, Cs¹⁺, and mixtures thereof.

In all embodiments described herein, moiety XY₄ is a polyanion selected from the group consisting of X′[O₄₋ₓ,Y′ₓ], X′[O_{4-y},Y′_{2y}], X″S₄, [X_{z}′″,X′_{1-z}]O₄, and mixtures thereof, wherein:
(a) X′ and X′″ are each independently selected from the group consisting of P, As, Sb, Si, Ge, V, S, and mixtures thereof;
(b) X″ is selected from the group consisting of P, As, Sb, Si, Ge, V, and mixtures thereof;
(c) Y′ is selected from the group consisting of a halogen, S, N, and mixtures thereof; and
(d) 0≦x≦3, 0≦y≦2, 0≦z≦1, and 1≦c≦3.

In one embodiment, XY₄ is selected from the group consisting of X′O₄₋ₓY′ₓ, X′O_{4-y}Y′_{2y}, and mixtures thereof, and x and y are both 0 (x,y=0). Stated otherwise, XY₄ is a polyanion selected from the group consisting of PO₄, SiO₄, GeO₄, VO₄, AsO₄, SbO₄, SO₄, and mixtures thereof. Preferably, XY₄ is PO₄ (a phosphate group) or a mixture of PO₄ with another anion of the above-noted group (i.e., where X′ is not P, Y′ is not O, or both, as defined above). In one embodiment, XY₄ includes about 80% or more phosphate and up to about 20% of one or more of the above-noted anions.

In another embodiment, XY₄ is selected from the group consisting of X′[O₄₋ₓ,Y′ₓ], X′[O_{4-y}Y′_{2y}], and mixtures thereof, and 0<x≦3 and 0<y≦2, wherein a portion of the oxygen (O) in the XY₄ moiety is substituted with a halogen, S, N, or a mixture thereof.

In all embodiments described herein, moiety Z (when provided) is selected from the group consisting of OH (Hydroxyl), a halogen, or mixtures thereof. In one embodiment, Z is selected from the group consisting of OH, F (Fluorine), Cl (Chlorine), Br (Bromine), and mixtures thereof. In another embodiment, Z is OH. In another embodiment, Z is F, or a mixture of F with OH, Cl, or Br. Where the moiety Z is incorporated into the active material of the present invention, the active material may not take on a NASICON structural. It is quite normal for the symmetry to be reduced with incorporation of, for example, one or more halogens.

The composition of the electrode active material, as well as the stoichiometric values of the elements of the composition, are selected so as to maintain electroneutrality of the electrode active material. The stoichiometric values of one or more elements of the composition may take on non-integer values. Preferably, the XY₄ moiety is, as a unit moiety, an anion having a charge of −2, −3, or −4, depending on the selection of X′, X″, X′″ Y′, and x and y. When XY₄ is a mixture of polyanions such as the preferred phosphate/phosphate substitutes discussed above, the net charge on the XY₄ anion may take on non-integer values, depending on the charge and composition of the individual groups XY₄ in the mixture.

In one embodiment, the electrode active material is represented by the general formula (II):
AₐM_{b}(PO₄)Z_{d}, (II)
wherein moieties A, M, and Z are as described herein above, 0.1<a≦4, 8≦b≦1.2 and 0≦d≦4; and wherein A, M, Z, a, b, and d are selected so as to maintain electroneutrality of the electrode active material in its nascent or as-synthesized state. Specific examples of electrode active materials represented by general formula (II), wherein d>0, include Li₂Fe_{0.9}Mg_{0.1}PO4F, Li₂Fe_{0.8}Mg_{0.2}PO₄F, Li₂Fe_{0.95}Mg_{0.05}PO₄F, Li₂CoPO₄F, Li₂FePO₄F, and Li₂MnPO₄F.

In a subembodiment, M includes at least one element from Groups 4 to 11 of the Periodic Table, and at least one element from Groups 2, 3, and 12-16 of the Periodic Table. In a particular subembodiment, M includes an element selected from the group consisting of Fe, Co, Mn, Cu, V, Cr, and mixtures thereof; and a metal selected from the group consisting of Mg, Ca, Zn, Ba, Al, and mixtures thereof.

In another embodiment, the electrode active material is represented by the general formula (III):
AM′₁₋ⱼM″ⱼPO₄, (III)
wherein moiety A is as described herein above, and wherein M′ is at least one transition metal from Groups 4 to 11 of the Periodic Table and has a +2 valence state; M″ is at least one metallic element which is from Group 2, 12, or 14 of the Periodic Table and has a +2 valence state; and 0<j<1. In one subembodiment, M′ is selected from the group consisting of Fe, Co, Mn, Cu, V, Cr, Ni, and mixtures thereof; more preferably M′ is selected from Fe, Co, Ni, Mn and mixtures thereof. Preferably, M″ is selected from the group consisting of Mg, Ca, Zn, Ba, and mixtures thereof.

In another embodiment, the electrode active material is represented by the general formula (IV):
LiFe_{1-q}M″_{q}PO₄, (IV)
wherein M″ is selected from the group consisting of Mg, Ca, Zn, Sr, Pb, Cd, Sn, Ba, Be, and mixtures thereof; and 0<q<1. In one subembodiment, 0<q≦0.2. In a another subembodiment, M″ is selected from the group consisting of Mg, Ca, Zn, Ba, and mixtures thereof, more preferably, M is Mg. In another subembodiment the electrode active material is represented by the formula LiFe_{1-q}Mg_{q}PO₄, wherein 0<q≦0.5. Specific examples of electrode active materials represented by general formula (IV) include LiFe_{0.8}Mg_{0.2}PO₄, LiFe_{0.9}Mg_{0.1}PO₄, and LiFe_{0.95}Mg_{0.05}PO₄.

In another embodiment, the electrode active material is represented by the general formula (V):
AₐCoᵤFeᵥM¹³_{w}M¹⁴ₐₐM¹⁵_{bb}XY₄, (V)

wherein:
(i) moiety A is as described herein above, 0<a≦2
(ii) u>0 and v>0;
(iii) M¹³ is one or more transition metals, wherein w≧0;
(iv) M¹⁴ is one or more +2 oxidation state non-transition metals, wherein aa≧0;
(v) M¹⁵ is one or more +3 oxidation state non-transition metals, wherein bb≧0;
(vi) XY₄ is selected from the group consisting of X′O₄₋ₓY′ₓ, X′O_{4-y}Y′_{2y}, X″S₄, and mixtures thereof, where X′ is selected from the group consisting of P, As, Sb, Si, Ge, V, S, and mixtures thereof; X″ is selected from the group consisting of P, As, Sb, Si, Ge, V and mixtures thereof; Y′ is selected from the group consisting of halogen, S, N, and mixtures thereof; 0≦x≦3; and 0<y≦2; and

wherein 0<(u+v+w+aa+bb)<2, and M¹³, M¹⁴, M¹⁵, XY₄, a, u, v, w, aa, bb, x, and y are selected so as to maintain electroneutrality of the electrode active material in its nascent or as-synthesized state. In one subembodiment, 0.8≦(u+v+w+aa+bb)≦1.2, wherein u≧0.8 and 0.05≦v≦0.15. In another subembodiment, 0.8≦(u+v+w+aa+bb)≦1.2, wherein u≧0.5, 0.01≦v≦0.5, and 0.01≦w≦50.5.

In one subembodiment, M¹³ is selected from the group consisting of Ti, V, Cr, Mn, Ni, Cu and mixtures thereof. In another subembodiment, M¹³ is selected from the group consisting of Mn, Ti, and mixtures thereof. In another subembodiment, M¹⁴ is selected from the group consisting of Be, Mg, Ca, Sr, Ba, and mixtures thereof. In one particular subembodiment, M¹⁴ is Mg and 0.01≦bb≦0.2, preferably 0.01≦bb≦0.1. In another particular subembodiment, M¹⁵ is selected from the group consisting of B, Al, Ga, In, and mixtures thereof.

In another embodiment, the electrode active material is represented by the general formula (VI):
LiM(PO₄₋ₓY′ₓ), (VI)

wherein M is M¹⁶_{cc}M¹⁷_{dd}M¹⁸ₑₑM¹⁹_{ff,} and

(i) M¹⁶ is one or more transition metals;

(ii) M¹⁷ is one or more +2 oxidation state non-transition metals;

(iii) M¹⁸ is one or more +3 oxidation state non-transition metals;

(iv) M¹⁹ is one or more +1 oxidation state non-transition metals;

(v) Y′ is halogen; and

wherein cc>0, each of dd, ee, and ff≧0, (cc+dd+ee+ff)≦1, and 0≦x≦0.2. In one subembodiment, cc≧0.8. In another subembodiment, 0.01≦(dd+ee)≦0.5, preferably 0.01≦dd≦0.2 and 0.01≦ee≦0.2. In another subembodiment x=0.

In one particular subembodiment, M¹⁶ is a +2 oxidation state transition metal selected from the group consisting of V, Cr, Mn, Fe, Co, Cu, and mixtures thereof. In another subembodiment, M¹⁶ is selected from the group consisting of Fe, Co, and mixtures thereof. In a preferred subembodiment M¹⁷ is selected from the group consisting of Be, Mg, Ca, Sr, Ba and mixtures thereof. In a preferred subembodiment M¹⁸ is Al. In one subembodiment, M¹⁹ is selected from the group consisting of Li, Na, and K, wherein 0.01≦ff≦0.2. In a preferred subembodiment M¹⁹ is Li. In one preferred subembodiment x=0, (cc+dd+ee+ff)=1, M¹⁷ is selected from the group consisting of Be, Mg, Ca, Sr, Ba and mixtures thereof, preferably 0.01≦dd≦0.1, M¹⁸ is Al, preferably 0.01≦ee≦0.1, and M¹⁹ is Li, preferably 0.01≦ff≦0.1. In another preferred subembodiment, 0<x≦0, preferably 0.01≦x≦0.05, and (cc+dd+ee+ff)<1, wherein cc≧0.8, 0.01≦dd≦0.1 0.01≦ee≦0.1 and ff=0. Preferably (cc+dd+ee)=1−x.

In another embodiment, the electrode active material is represented by the general formula (VII):
A¹ₐ(MO)_{b}M′_{1-b}XO₄, (VIII)

wherein
(i) A¹ is independently selected from the group consisting of Li, Na, K and mixtures thereof, 0.1<a<2;
(ii) M comprises at least one element, having a +4 oxidation state, which is redox active; 0<b≦1;
(iii) M′ is one or more metals selected from metals having a +2 and a +3 oxidation state; and
(iv) X is selected from the group consisting of P, As, Sb, Si, Ge, V, S, and mixtures thereof.

In one subembodiment, A¹ is Li. In another subembodiment, M is selected from a group consisting of +4 oxidation state transition metals. In a preferred subembodiment, M is selected from the group comprising Vanadium (V), Tantalum (Ta), Niobium (Nb), molybdenum (Mo), and mixtures thereof. In another preferred subembodiment M comprises V, and b=1. M′ may generally be any +2 or +3 element, or mixture of elements. In one subembodiment, M′ is selected from the group consisting V, Cr, Mn, Fe, Co, Ni, Mo, Ti, Al, Ga, In, Sb, Bi, Sc, and mixtures thereof. In another subembodiment, M′ is selected from the group consisting of V, Cr, Mn, Fe, Co, Ni, Ti, Al, and mixtures thereof. In one preferred subembodiment, M′ comprises Al. Specific examples of electrode active materials represented by general formula (VII) include LIVOPO₄, Li(VO)_{0.75}Mn_{0.25}PO₄, Li_{0.75}Na_{0.25}VOPO₄, and mixtures thereof.

In another embodiment, the electrode active material is represented by the general formula (VIII):
AₐM_{b}(XY₄)₃Z_{d}, (VIII)

wherein moieties A, M XY₄ and Z are as described herein above, 2≦a≦8, 1≦b≦3, and 0≦d≦6; and

wherein M, XY₄, Z, a, b, d, x and y are selected so as to maintain electroneutrality of the electrode active material in its nascent or as-synthesized state.

In one subembodiment, A comprises Li, or mixtures of Li with Na or K. In another preferred embodiment, A comprises Na, K, or mixtures thereof. In another subembodiment, M is selected from the group consisting of Fe, Co, Ni, Mn, Cu, V, Zr, Ti, Cr, and mixtures thereof. In another subembodiment, M comprises two or more transition metals from Groups 4 to 11 of the Periodic Table, preferably transition metals selected from the group consisting of Fe, Co, Ni, Mn, Cu, V, Zr, Ti, Cr, and mixtures thereof. In subembodiment, M comprises M′₁₋ₘM″ₘ, where M′ is at least one transition metal from Groups 4 to 11 of the Periodic Table; and M″ is at least one element from Groups 2, 3, and 12-16 of the Periodic Table; and 0<m<1. Preferably, M′ is selected from the group consisting of Fe, Co, Ni, Mn, Cu, V, Zr, Ti, Cr, and mixtures thereof; more preferably M′ is selected from the group consisting of Fe, Co, Mn, Cu, V, Cr, and mixtures thereof Preferably, M″ is selected from the group consisting of Mg, Ca, Zn, Sr, Pb, Cd, Sn, Ba, Be, Al, and mixtures thereof; more preferably, M″ is selected from the group consisting of Mg, Ca, Zn, Ba, Al, and mixtures thereof. In a preferred embodiment, XY₄ is PO₄. In another subembodiment, X′ comprises As, Sb, Si, Ge, S, and mixtures thereof; X″ comprises As, Sb, Si, Ge and mixtures thereof; and 0<x<3. In a preferred embodiment, Z comprises F, or mixtures of F with Cl, Br, OH, or mixtures thereof. In another preferred embodiment, Z comprises OH, or mixtures thereof with Cl or Br. One particular example of an electrode active material represented by general formula (VIII) is Li₃V₂(PO₄)₃.

Non-limiting examples of active materials represented by general formulas (I) through (VIII) include the following: Li_{0.95}Co_{0.8}Fe_{0.15}Al_{0.05}PO₄, Li_{1.025}Co_{0.85}Fe_{0.05}Al_{0.025}Mg_{0.05}PO₄, Li_{1.025}Co_{0.80}Fe_{0.10}Al_{0.025}Mg_{0.05}PO₄, Li_{1.025}Co_{0.45}Fe_{0.45}Al_{0.025}Mg_{0.05}PO₄, Li_{1.025}Co_{0.75}Fe_{0.15}Al_{0.025}Mg_{0.05}PO₄, Li_{1.025}Co_{0.7}(Fe_{0.4}Mn_{0.6})_{0.2}Al_{0.025}Mg_{0.05}PO₄, Li_{1.025}Co_{0.75}Fe_{0.15}Al_{0.025}Mg_{0.05}PO₄, Li_{1.025}Co_{0.85}Fe_{0.05}Al_{0.025}Mg_{0.05}PO₄, Li_{1.025}Co_{0.7}Fe_{0.08}Mn_{0.12}Al_{0.025}Mg_{0.05}PO₄, LiCo_{0.75}Fe_{0.15}Al_{0.025}Ca_{0.05}PO_{3.975}F_{0.025}, LiCo_{0.80}Fe_{0.10}Al_{0.025}Ca_{0.05}PO_{3.975}F_{0.025}, Li_{1.25}Co_{0.6}Fe_{0.1}Mn_{0.075}Mg_{0.025}Al_{0.05}PO₄, Li_{1.0}Na_{0.25}Co_{0.6}F_{0.1}Cu_{0.075}Mg_{0.025}Al_{0.05}PO₄, Li_{1.025}Co_{0.8}Fe_{0.1}Al_{0.025}Mg_{0.075}PO₄, Li_{1.025}Co_{0.6}Fe_{0.05}Al_{0.12}Mg_{0.0325}PO_{3.75}F_{0.25}, Li_{1.025}Co_{0.7}Fe_{0.1}Mg_{0.0025}Al_{0.04}PO_{3.75}F_{0.25}, Li_{0.75}Co_{0.5}Fe_{0.05}Mg_{0.015}Al_{0.04}PO₃F, Li_{0.75}Co_{0.5}Fe_{0.025}Cu_{0.025}Be_{0.015}Al_{0.04}PO₃F, Li_{0.75}Co_{0.5}Fe_{0.025}Mn_{0.025}Ca_{0.015}Al_{0.04}PO₃F, Li_{1.025}Co_{0.6}Fe_{0.05}B_{0.12}Ca_{0.0325}PO_{3.75}F_{0.25}, Li_{1.025}Co_{0.65}Fe_{0.65}Mg_{0.0125}Al_{0.1}PO_{3.75}F_{0.25}, Li_{1.025}Co_{0.65}Fe_{0.05}Mg_{0.065}Al_{0.14}PO_{3.975}F_{0.025}, Li_{1.075}Co_{0.8}Fe_{0.05}Mg_{0.025}Al_{0.05}PO_{3.975}F_{0.025}, LiCo_{0.8}Fe_{0.1}Al_{0.025}Mg_{0.05}PO_{3.975}F_{0.025}, Li_{0.25}Fe_{0.7}Al_{0.45}PO₄, LiMnAl_{0.067}(PO₄)_{0.8}(SiO₄)_{0.2}, Li_{0.95}CO_{0.9}Al_{0.05}Mg_{0.05}PO₄, Li_{0.95}Fe_{0.8}Ca_{0.15}Al_{0.05}PO₄, Li_{0.25}MnBe_{0.425}Ga_{0.3}SiO₄, Li_{0.5}Na_{0.25}Ca_{0.0375}Al_{0.1}PO₄, Li_{0.25}Al_{0.25}Mg_{0.25}Co_{0.75}PO₄, Na_{0.55}B_{0.15}Ni_{0.75}Ba_{0.25}PO₄, Li_{1.025}Co_{0.9}Al_{0.025}Mg_{0.05}PO₄, K_{1.025}Ni_{0.09}Al_{0.025}Ca_{0.05}PO₄, Li_{0.95}Co_{0.9}Al_{0.05}Mg_{0.05}PO₄, Li_{0.95}Fe_{0.8}Ca_{0.15}Al_{0.05}PO₄,

Li_{1.025}Co_{0.7}(Fe_{0.4}Mn_{0.6})_{0.2}Al_{0.025}Mg_{0.05}PO₄, Li_{1.025}Co_{0.8}Fe_{0.1}Al_{0.025}Mg_{0.05}PO₄, Li_{1.025}Co_{0.9}Al_{0.025}Mg_{0.05}PO₄, Li_{1.025}Co_{0.75}Fe_{0.15}Al_{0.025}Mg_{0.025}PO₄,

LiCo_{0.75}Fe_{0.15}Al_{0.025}Ca_{0.05}PO_{3.975}F_{0.251}, LiCo_{0.9}Al_{0.025}Mg_{0.05}PO_{3.975}F_{0.025},

Li_{0.75}Co_{0.625}Al_{0.25}PO_{3.75}F_{0.25}, Li_{1.075}Co_{0.8}Cu_{0.05}Mg_{0.025}Al_{0.05}PO_{3.975}F_{0.025}, Li_{1.075}Fe_{0.8}Mg_{0.075}Al_{0.05}PO_{3.975}F_{0.025}, Li_{1.075}Co_{0.8}Mg_{0.075}Al_{0.05}PO_{3.975}F_{0.025}, Li_{1.025}Co_{0.8}Mg_{0.1}Al_{0.05}PO_{3.975}F_{0.025}, LiCo_{0.7}Fe_{0.2}Al_{0.025}Mg_{0.05}PO_{3.975}F_{0.025},

Li₂Fe_{0.8}Mg_{0.2}PO₄F; Li₂Fe_{0.5}Co_{0.5}PO₄F; Li₃CoPO₄F₂; KFe(PO₃F)F; Li₂Co(PO₃F)Br₂; Li₂Fe(PO₃F₂)F; Li₂FePO₄Cl; Li₂MnPO₄OH; Li₂CoPO₄F; Li₂Fe_{0.5}Co_{0.5}PO₄F; Li₂Fe_{0.9}Mg_{0.1}PO₄F; Li₂Fe_{0.8}Mg_{0.2}PO₄F; Li_{1.25}Fe_{0.9}Mg_{0.1}PO₄F_{0.25}; Li₂MnPO₄F; Li₂CoPO₄F; K₂Fe_{0.9}Mg_{0.1}P_{0.5}As_{0.5}O₄F; Li₂MnSbO₄OH; Li₂Fe_{0.6}Co_{0.4}SbO₄Br; Na₃CoAsO₄F₂; LiFe(AsO₃F)Cl; Li₂Co(As_{0.5}Sb_{0.5}O₃F)F₂; K₂Fe(AsO₃F₂)F; Li₂NiSbO₄F; Li₂FeAsO₄OH; Li₄Mn₂(PO₄)₃F; Na₄FeMn(PO₄)₃OH; Li₄FeV(PO₄)₃Br; Li₃VAl(PO₄)₃F; K₃VAl(PO₄)₃Cl; LiKNaTiFe(PO₄)₃F; Li₄Ti₂(PO₄)₃Br; Li₃V₂(PO₄)₃F₂; Li₆FeMg(PO₄)₃OH; Li₄Mn₂(AsO₄)₃F; K₄FeMn(AsO₄)₃OH; Li₄FeV(PO_{0.5}Sb_{0.5}O₄)₃Br; LiNaKAlV(AsO₄)₃F; K₃VAl(SbO₄)₃Cl; Li₃TiV(SbO₄)₃F; Li₂FeMn(P_{0.5}As_{0.5}O₃F)₃; Li₄Ti₂(PO₄)₃F; Li_{3.25}V₂(PO₄)₃F_{0.25}; Li₃Na_{0.75}Fe₂(PO₄)₃F_{0.75}; Na_{6.5}Fe₂(PO₄)₃(OH)Cl_{0.5}; K₈Ti₂(PO₄)₃F₃Br₂; K₈Ti₂(PO₄)₃F₅; Li₄Ti₂(PO₄)₃F; LiNa_{1.25}V₂(PO₄)₃F_{0.5}Cl_{0.75}; K_{3.25}Mn₂(PO₄)₃OH_{0.25}; LiNa_{1.25}KTiV(PO₄)₃(OH)_{1.25}Cl; Na₈Ti₂(PO₄)₃F₃Cl₂; Li₇Fe₂(PO₄)₃F₂; Li₈FeMg(PO₄)₃F_{2.25}Cl_{0.75}; Li₅Na_{2.5}TiMn(PO₄)₃(OH)₂Cl_{0.5}; Na₃K_{4.5}MnCa(PO₄)₃(OH)_{1.5}Br; K₉FeBa(PO₄)₃F₂Cl₂; Li₇Ti₂(SiO₄)₂(PO₄)F₂; Na₈Mn₂(SiO₄)₂(PO₄)F₂Cl; Li₃K₂V₂(SiO₄)₂(PO₄)(OH)Cl; Li₄Ti₂(SiO₄)₂(PO₄)(OH); Li₂NaKV₂(SiO₄)₂(PO₄)F; Li₅TiFe(PO₄)₃F; Na₄K₂VMg(PO₄)₃FCl; Li₄NaAlNi(PO₄)₃(OH); Li₄K₃FeMg(PO₄)₃F₂; Li₂Na₂K₂CrMn(PO₄)₃(OH)Br; Li₅TiCa(PO₄)₃F; Li₄Ti_{0.75}Fe_{1.5}(PO₄)₃F; Li₃NaSnFe(PO₄)₃(OH); Li₃NaGe_{0.5}Ni₂(PO₄)₃(OH); Na₃K₂VCo(PO₄)₃(OH)Cl; Li₄Na₂MnCa(PO₄)₃F(OH); Li₃NaKTiFe(PO₄)₃F; Li₇FeCo(SiO₄)₂(PO₄)F; Li₃Na₃TiV(SiO₄)₂(PO₄)F; K_{5.5}CrMn(SiO₄)₂(PO₄)Cl_{0.5}; Li₃Na_{2.5}V₂(SiO₄)₂(PO₄)(OH)_{0.5}; Na_{5.25}FeMn(SiO₄)₂(PO₄)Br_{0.25}; Li_{6.5}VCo(SiO₄)_{2.5}(PO₄)_{0.5}F; Na_{7.25}V₂(SO₄)_{2.25}(PO₄)_{0.75}F₂; Li₄NaVTi(SiO₄)₃F_{0.5}Cl_{0.5}; Na₂K_{2.5}ZrV(SiO₄)₃F_{0.5}; Li₄K₂MnV(SiO₄)₃(OH)₂; Li₃Na₃KTi₂(SiO₄)₃F; K₆V₂(SiO₄)₃(OH)Br; Li₈FeMn(SiO₄)₃F₂; Na₃K_{4.5}MnNi(SiO₄)₃(OH)_{1.5}; Li₃Na₂K₂TiV(SiO₄)₃(OH)_{0.5}Cl_{0.5}; K₉VCr(SiO₄)₃F₂Cl; Li₄Na₄V₂(SiO₄)₃FBr; Li₄FeMg(SO₄)₃F₂; Na₂KNiCo(SO₄)₃(OH); Na₅MnCa(SO₄)₃F₂Cl; Li₃NaCoBa(SO₄)₃FBr; Li_{2.5}K_{0.5}FeZn(SO₄)₃F; Li₃MgFe(SO₄)₃F₂; Li₂NaCaV(SO₄)₃FCl; Na₄NiMn(SO₄)₃(OH)₂; Na₂KBaFe(SO₄)₃F; Li₂KCuV(SO₄)₃(OH)Br; Li_{1.5}CoPO₄F_{0.5}; Li_{1.25}CoPO₄F_{0.25}; Li_{1.75}FePO₄F_{0.75}; Li_{1.66}MnPO₄F_{0.66}; Li_{1.5}Co_{0.75}Ca_{0.25}PO₄F_{0.5}; Li_{1.75}Co_{0.8}Mn_{0.2}PO₄F_{0.75}; Li_{1.25}Fe_{0.75}Mg_{0.25}PO₄F_{0.25}; Li_{1.66}Co_{0.6}Zn_{0.4}PO₄F_{0.66}; KMn₂SiO₄Cl; Li₂VSiO₄(OH)₂; Li₃CoGeO₄F; LiMnSO₄F; NaFe_{0.9}Mg_{0.1}SO₄Cl; LiFeSO₄F; LiMnSO₄OH; KMnSO₄F; Li_{1.75}Mn_{0.8}Mg_{0.2}PO₄F_{0.75}; Li₃FeZn(PO₄)F₂; Li_{0.5}V_{0.75}Mg_{0.5}(PO₄)F_{0.75}; Li₃V_{0.5}Al_{0.5}(PO₄)F_{3.5}; Li_{0.75}VCa(PO₄)F_{1.75}; Li₄CuBa(PO₄)F₄; Li_{0.5}V_{0.5}Ca(PO₄)(OH)_{1.5}; Li_{1.5}FeMg(PO₄)(OH)Cl; LiFeCoCa(PO₄)(OH)₃F; Li₃CoBa(PO₄)(OH)₂Br₂; Li_{0.75}Mn_{1.5}Al(PO₄)(OH)_{3.75}; Li₂Co_{0.75}Mg_{0.25}(PO₄)F; LiNaCo_{0.8}Mg_{0.2}(PO₄)F; NaKCo_{0.5}Mg_{0.5}(PO₄)F; LiNa_{0.5}K_{0.5}Fe_{0.75}Mg_{0.25}(PO₄)F; Li_{1.5}K_{0.5}V_{0.5}Zn_{0.5}(PO₄)F₂; Na₆Fe₂Mg(PS₄)₃(OH₂)Cl; Li₄Mn_{1.5}Co_{0.5}(PO₃F)₃(OH)_{3.5}; K₈FeMg(PO₃F)₃F₃Cl₃ Li₅Fe₂Mg(SO₄)₃Cl₅; LiTi₂(SO₄)₃Cl, LiMn₂(SO₄)₃F, Li₃Ni₂(SO₄)₃Cl, Li₃Co₂(SO₄)₃F, Li₃Fe₂(SO₄)₃Br, Li₃Mn₂(SO₄)₃F, Li₃MnFe(SO₄)₃F, Li₃NiCo(SO₄)₃Cl; LiMnSO₄F; LiFeSO₄Cl; LiNiSO₄F; LiCoSO₄Cl; LiMn₁₋ₓFeₓSO₄F, LiFe₁₋ₓMgₓSO₄F; Li₇ZrMn(SiO₄)₃F; Li₇MnCo(SiO₄)₃F; Li₇MnNi(SiO₄)₃F; Li₇VAl(SiO₄)₃F; Li₅MnCo(PO₄)₂(SiO₄)F; Li₄VAl(PO₄)₂(SiO₄)F; Li₄MnV(PO₄)₂(SiO₄)F; Li₄VFe(PO₄)₂(SiO₄)F; Li_{0.6}VPO₄F_{0.6}; Li_{0.8}VPO₄F_{0.8}; LiVPO₄F; Li₃V₂(PO₄)₂F₃; LiVPO₄Cl; LiVPO₄OH; NaVPO₄F; Na₃V₂(PO₄)₂F₃; LiV_{0.9}Al_{0.1}PO₄F; LiFePO₄F; LiTiPO₄F; LiCrPO₄F; LiFePO₄; LiCoPO₄, LiMnPO₄; LiFe_{0.9}Mg_{0.1}PO₄; LiFe_{0.8}Mg_{0.2}PO₄; LiFe_{0.95}Mg_{0.05}PO₄; LiFe_{0.9}Ca_{0.1}PO₄; LiFe_{0.8}Ca_{0.2}PO₄; LiFe_{0.8}Zn_{0.2}PO₄; LiMn_{0.8}Fe_{0.2}PO₄; LiMn_{0.9}Fe_{0.8}PO₄; Li₃V₂(PO₄)₃; Li₃Fe₂(PO₄)₃; Li₃Mn₂(PO₄)₃; Li₃FeTi(PO₄)₃; Li₃CoMn(PO₄)₃; Li₃FeMn(PO₄)₃; Li₃VTi(PO₄)₃; Li₃FeCr(PO₄)₃; Li₃FeMo(PO₄)₃; Li₃FeNi(PO₄)₃; Li₃FeMn(PO₄)₃; Li₃FeAl(PO₄)₃; Li₃FeCo(PO₄)₃; Li₃Ti₂(PO₄)₃; Li₃TiCr(PO₄)₃; Li₃TiMn(PO₄)₃; Li₃TiMo(PO₄)₃; Li₃TiCo(PO₄)₃; Li₃TiAl(PO₄)₃; Li₃TiNi(PO₄)₃; Li₃ZeMnSiP₂O₁₂; Li₃V₂SiP₂O₁₂; Li₃MnVSiP₂O₁₂; Li₃TiVSiP₂O₁₂; Li₃TiCrSiP₂O₁₂; Li_{3.5}AlVSi_{0.5}P_{2.5}O₁₂; Li_{3.5}V2Si_{0.5}P_{2.5}O₁₂; Li_{2.5}AlCrSi_{0.5}P_{2.5}O₁2; Li_{2.5}V₂P₃O_{11.5}F_{0.5}; Li₂V₂P₃O₁₁F; Li_{2.5}VMnP₃O_{11.5}F_{0.5}; Li₂V_{0.5}Fe_{1.5}P₃O₁₁F; Li₃V_{0.5}V_{1.5}P₃O_{11.5}F_{0.5}; Li₃V₂P₃O₁₁F; Li₃Mn_{0.5}V_{1.5}P₃O₁₁F_{0.5}; LiCo_{0.8}Fe_{0.1}Ti_{0.025}Mg_{0.05}PO₄; Li_{1.025}Co_{0.8}Fe_{0.1}Ti_{0.025}Al_{0.025}PO₄; Li_{1.0250}Co_{0.8}Fe_{0.1}Ti_{0.025}Mg_{0.025}PO_{3.975}F_{0.025}; LiCo_{0.825}Fe_{0.1}Ti_{0.025}Mg_{0.025}PO₄; LiCo_{0.85}Fe_{0.075}Ti_{0.025}Mg_{0.025}PO₄; LiCo_{0.8}Fe_{0.1}Ti_{0.025}Al_{0.025}Mg_{0.025}PO₄, Li_{1.025}Co_{0.8}Fe_{0.1}Ti_{0.025}Mg_{0.05}PO₄, Li_{1.025}Co_{0.8}Fe_{0.1}Ti_{0.025}Al_{0.025}Mg_{0.025}PO₄, LiCo_{0.8}Fe_{0.1}Ti_{0.05}Mg_{0.05}PO₄, LiVOPO₄, Li(VO)_{0.75}Mn_{0.25}PO₄, NaVOPO₄, Li_{0.75}Na_{0.25}VOPO₄, Li(VO)_{0.5}Al_{0.5}PO₄, Na(VO)_{0.75}Fe_{0.25}PO₄, Li_{0.5}Na_{0.5}VOPO₄, Li(VO)_{0.75}Co_{0.25}PO₄, Li(VO)_{0.75}Mo_{0.25}PO₄, LiVOSO₄, and mixtures thereof.

Preferred active materials include LiFePO₄; LiCoPO₄, LiMnPO₄; LiMn_{0.8}Fe_{0.2}PO₄; LiMn_{0.9}Fe_{0.8}PO₄; LiFe_{0.9}Mg_{0.1}PO₄; LiFe_{0.8}Mg_{0.2}PO₄, LiFe_{0.95}Mg_{0.05}PO₄; Li_{1.025}Co_{0.85}Fe_{0.05}Al_{0.025}Mg_{0.05}PO₄, Li_{1.025}CO_{0.80}Fe_{0.10}Al_{0.025}Mg_{0.05}PO₄, Li_{1.025}Co_{0.75}Fe_{0.15}Al_{0.025}Mg_{0.05}PO₄, Li_{1.025}Co_{0.7}(Fe_{0.4}Mn_{0.6})_{0.2}Al_{0.025}Mg_{0.05}PO₄, LiCo_{0.8}Fe_{0.1}Al_{0.025}Ca_{0.05}PO_{3.975}F_{0.025}, LiCo_{0.8}Fe_{0.1}Al_{0.025}Mg_{0.05}PO_{3.975}F_{0.025}, LiCo_{0.8}Fe_{0.1}Ti_{0.025}Mg_{0.05}PO₄; Li_{1.025}Co_{0.8}Fe_{0.1}Ti_{0.025}Al_{0.025}PO₄; Li_{1.25}Co_{0.8}Fe_{0.1}Ti_{0.025}PO₄; LiCo_{0.825}Fe_{0.1}Ti_{0.025}Mg_{0.025}PO₄; LiCo_{0.85}Fe_{0.075}Ti_{0.025}Mg_{0.025}PO₄; LiVOPO₄; Li(VO)_{0.75}Mn_{0.25}PO₄; and mixtures thereof. A particularly preferred active material is LiCo_{0.8}Fe_{0.1}Al_{0.025}Mg_{0.05}PO_{3.975}F_{0.025}.

Methods of making the electrode active materials described by general formulas (I) through (VIII), are described are described in: WO 01/54212 to Barker et al., published Jul. 26, 2001; International Publication No. WO 98/12761 to Barker et al., published Mar. 26, 1998; WO 00/01024 to Barker et al., published Jan. 6, 2000; WO 00/31812 to Barker et al., published Jun. 2, 2000; WO 00/57505 to Barker et al., published Sep. 28, 2000; WO 02/44084 to Barker et al., published Jun. 6, 2002; WO 03/085757 to Saidi et al., published Oct. 16, 2003; WO 03/085771 to Saidi et al., published Oct. 16, 2003; WO 03/088383 to Saidi et al., published Oct. 23, 2003; U.S. Pat. No. 6,528,033 to Barker et al., issued Mar. 4, 2003; U.S. Pat. No. 6,387,568 to Barker et al., issued May 14, 2002; U.S. Publication No. 2003/0027049 to Barker et al., published Feb. 2, 2003; U.S. Publication No. 2002/0192553 to Barker et al., published Dec. 19, 2002; U.S. Publication No. 2003/0170542 to Barker at al., published Sep. 11, 2003; and U.S. Publication No. 2003/1029492 to Barker et al., published Jul. 10, 2003; the teachings of all of which are incorporated herein by reference.

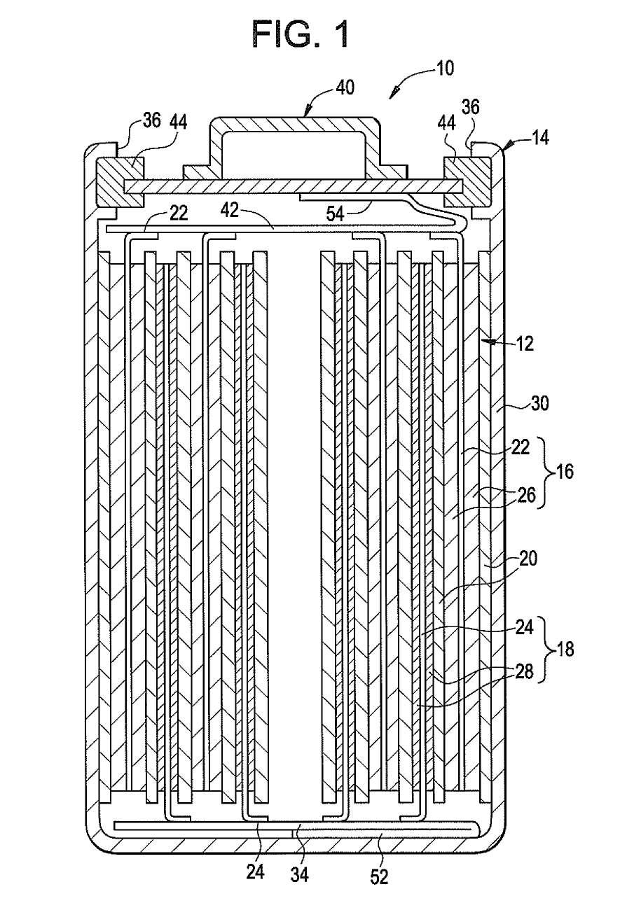

Referring to FIGS. 1 through 3, a novel secondary electrochemical cell 10 having an electrode active material represented by general formulas (I) through (VIII), includes a spirally coiled or wound electrode assembly 12 having a top 12a and a bottom 12b and enclosed in a sealed container, preferably a rigid cylindrical casing 14 having an open end. The electrode assembly 12 includes: a positive electrode 16 consisting of, among other things, an electrode active material represented by general formulas (I) through (VIII); a counter negative electrode 18; and one or more separators 20 interposed between and surrounding the first and second electrodes 16,18. The separator 20 is preferably an electrically insulating, ionically conductive microporous film, and composed of a polymeric material selected from the group consisting of polyethylene, polypropylene, polyethylene oxide, polyacrylonitrile and polyvinylidene fluoride, polymethyl methacrylate, polysiloxane, copolymers thereof, and admixtures thereof.

A non-aqueous electrolyte (not shown) is provided for transferring ionic charge carriers between the positive electrode 16 and the negative electrode 18 during charge and discharge of the electrochemical cell 10. The electrolyte includes a non-aqueous solvent and an alkali metal salt dissolved therein. Suitable solvents include: a cyclic carbonate such as ethylene carbonate, propylene carbonate, butylene carbonate or vinylene carbonate; a non-cyclic carbonate such as dimethyl carbonate, diethyl carbonate, ethyl methyl carbonate or dipropyl carbonate; an aliphatic carboxylic acid ester such as methyl formate, methyl acetate, methyl propionate or ethyl propionate; a .gamma.-lactone such as γ-butyrolactone; a non-cyclic ether such as 1,2-dimethoxyethane, 1,2-diethoxyethane or ethoxymethoxyethane; a cyclic ether such as tetrahydrofuran or 2-methyltetrahydrofuran; an organic aprotic solvent such as dimethylsulfoxide, 1,3-dioxolane, formamide, acetamide, dimethylformamide, dioxolane, acetonitrile, propyinitrile, nitromethane, ethyl monoglyme, phospheric acid triester, trimethoxymethane, a dioxolane derivative, sulfolane, methylsulfolane, 1,3-dimethyl-2-imidazolidinone, 3-methyl-2-oxazolidinone a propylene carbonate derivative, a tetrahydrofuran derivative, ethyl ether, 1,3-propanesultone, anisole, dimethylsulfoxide and N-methylpyrrolidone; and mixtures thereof. A mixture of a cyclic carbonate and a non-cyclic carbonate or a mixture of a cyclic carbonate, a non-cyclic carbonate and an aliphatic carboxylic acid ester, are preferred.

Suitable alkali metal salts, particularly lithium salts, include: LiClO₄; LiBF₄; LiPF₆; LiAlCl₄; LiSbF₆; LiSCN; LiCl; LiCF₃ SO₃; LiCF₃CO₂; Li(CF₃SO₂)₂; LiAsF₆; LiN(CF₃SO2)₂; LiB₁₀Cl₁₀; a lithium lower aliphatic carboxylate; LiCl; LiBr; Lil; a chloroboran of lithium; lithium tetraphenylborate; lithium imides, LiBOB (lithium bis(oxalato)borate); and mixtures thereof. In one embodiment, the electrolyte contains at least LiPF₆. In another embodiment, the electrolyte contains LiBOB.

Referring again to FIGS. 1 through 3, each electrode 16,18 includes a current collector 22 and 24, respectively, for providing electrical communication between the electrodes 16,18 and an external load. Each current collector 22,24 is a foil or grid of an electrically conductive metal such as iron, copper, aluminum, titanium, nickel, stainless steel, or the like, having a thickness of between 5 μm and 100 μm, preferably 5 μm and 20 μm. Optionally, the current collector may be surface cleaned using a plasma or chemical etching process, and coated with an electrically conductive coating for inhibiting the formation of electrically insulating oxides on the surface of the current collector 22,24. An examples of a suitable coatings include polymeric materials comprising a homogenously dispersed electrically conductive material (e.g. carbon), such polymeric materials including: acrylics including acrylic acid and methacrylic acids and esters, including poly (ethylene-coacrylic acid); vinylic materials including poly(vinyl acetate) and poly(vinylidene fluoride-co-hexafluoropropylene); polyesters including poly(adipic acid-coethylene glycol); polyurethanes; fluoroelastomers; and mixtures thereof.

The positive electrode 16 further includes a positive electrode film 26 formed on at least one side of the positive electrode current collector 22, preferably both sides of the positive electrode current collector 22, each film 26 having a thickness of between 10 μm and 150 μm, preferably between 25 μm an 125 μm, in order to realize the optimal capacity for the cell 10. The positive electrode film 26 is composed of between 80% and 95% by weight of an electrode active material represented by the nominal general formula (I), between 1% and 10% by weight binder, and between 1% and 10% by weight electrically conductive agent.

Suitable binders include: polyacrylic acid; carboxymethylcellulose; diacetylcellulose; hydroxypropylcellulose, polyethylene; polypropylene; ethylene-propylene-diene copolymer; polytetrafluoroethylene; polyvinylidene fluoride; styrene-butadiene rubber; tetrafluoroethylene-hexafluoropropylene copolymer; polyvinyl alcohol; polyvinyl chloride; polyvinyl pyrrolidone; tetrafluoroethylene-perfluoroalkylvinyl ether copolymer; vinylidene fluoride-hexafluoropropylene copolymer; vinylidene fluoride-chlorotrifluoroethylene copolymer; ethylenetetrafluoroethylene copolymer; polychlorotrifluoroethylene; vinylidene fluoride-pentafluoropropylene copolymer; propylene-tetrafluoroethylene copolymer; ethylene-chlorotrifluoroethylene copolymer; vinylidene fluoride-hexafluoropropylene-tetrafluoroethylene copolymer; vinylidene fluoride-perfluoromethylvinyl ether-tetrafluoroethylene copolymer; ethylene-acrylic acid copolymer; ethylene-methacrylic acid copolymer; ethylene-methyl acrylate copolymer; ethylene-methyl methacrylate copolymer; styrene-butadiene rubber; fluorinated rubber; polybutadiene; and admixtures thereof. Of these materials, most preferred are polyvinylidene fluoride and polytetrafluoroethylene.

Suitable electrically conductive agents include: natural graphite (e.g. flaky graphite, and the like); manufactured graphite; carbon blacks such as acetylene black, Ketzen black, channel black, furnace black, lamp black, thermal black, and the like, conductive fibers such as carbon fibers and metallic fibers; metal powders such as carbon fluoride, copper, nickel, and the like; and organic conductive materials such as polyphenylene derivatives.

The negative electrode 18 is formed of a negative electrode film 28 formed on at least one side of the negative electrode current collector 24, preferably both sides of the negative electrode current collector 24. The negative electrode film 28 is composed of between 80% and 95% of an intercalation material, between 2% and 10% by weight binder, and (optionally) between 1% and 10% by of an weight electrically conductive agent.

Intercalation materials suitable herein include: transition metal oxides, metal chalcogenides, carbons (e.g. graphite), and mixtures thereof. In one embodiment, the intercalation material is selected from the group consisting of crystalline graphite and amorphous graphite, and mixtures thereof, each such graphite having one or more of the following properties: a lattice interplane (002) d-value (d₍₀₀₂₎) obtained by X-ray diffraction of between 3.35 Å to 3.34 Å, inclusive (3.35 Å≦d₍₀₀₂₎≦3.34 Å), preferably 3.354 Å to 3.370 Å, inclusive (3.354 Å≦d₍₀₀₂₎≦3.370 Å; a crystallite size (L_{c}) in the c-axis direction obtained by X-ray diffraction of at least 200 Å, inclusive (L_{c}≧200 Å), preferably between 200 Å and 1,000 Å, inclusive (200 Å≦L_{c}≦1,000 Å); an average particle diameter (P_{d}) of between 1 μm to 30 μm, inclusive (1 μm≦P_{d}≦30 μm); a specific surface (SA) area of between 0.5 m²/g to 50 m²/g, inclusive (0.5 m²/g≦SA≦50 m²/g); and a true density (ρ) of between 1.9 g/cm³ to 2.25 g/cm³, inclusive (1.9 g/cm³>ρ≦2.25 g/cm³).

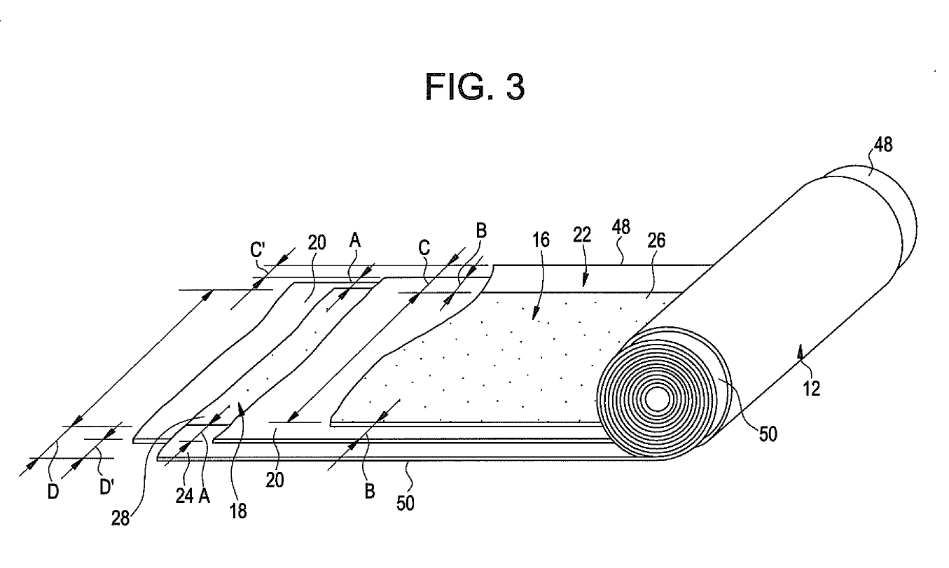

Referring again to FIGS. 1 and 3, to ensure that the electrodes 16,18 do not come into electrical contact with one another, in the event the electrodes 16,18 become offset during the winding operation during manufacture, the separator 20 is provided with a width “X” that is greater than the widths “Y”, “Z” of the positive and negative electrode films 26 and 28, respectively. This allows the separator 20 to “overhang” or extend a width “A” beyond each of the top and bottom long edges (26a and 26b, respectively) of the positive electrode film 26, and to “overhang” or extend a width “B” beyond each of the top and bottom long edges (28a and 28b, respectively) of the negative electrode film 28. In one embodiment, 50 μm≦A≦5,000 μm, and 50 μm≦B≦5,000 μm.

The cylindrical casing 14 includes a cylindrical body member 30 having a closed end 32 in electrical communication with the negative electrode 18 via a negative electrode plate 34, and an open end defined by crimped edge 36. In operation, the cylindrical body member 30, and more particularly the closed end 32, is electrically conductive and provides electrical communication between the negative electrode 18 and an external load (not illustrated).

A positive terminal subassembly 40 in electrical communication with the positive electrode 16 via a positive electrode plate 42 provides electrical communication between the positive electrode 16 and the external load (not illustrated). In one embodiment, the positive terminal subassembly 40 is adapted to sever electrical communication between the positive electrode 16 and an external load/charging device in the event of an overcharge condition (e.g. by way of positive temperature coefficient (PTC) element), elevated temperature and/or in the event of excess gas generation within the cylindrical casing 14. Suitable positive terminal assemblies 40 are disclosed in U.S. Pat. No. 6,632,572 to Iwaizono, et al., issued Oct. 14, 2003; and U.S. Pat. No. 6,667,132 to Okochi, et al., issued Dec. 23, 2003. A gasket member 44 sealingly engages the upper portion of the cylindrical body member 30 to the positive terminal subassembly 40.

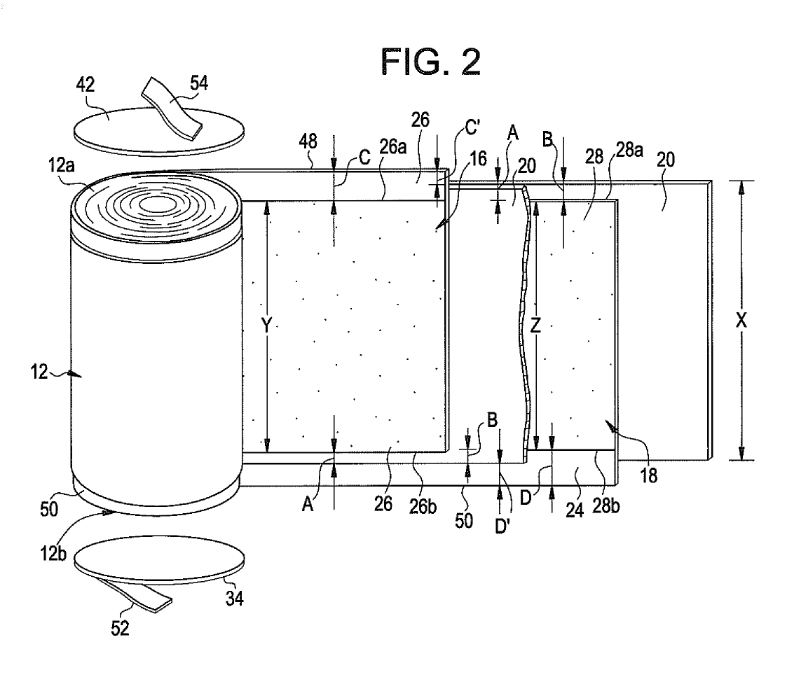

As shown in FIGS. 2 and 3, each electrode 16,18 is provided with a current collector exposed edge portion 48 and 50, respectively, which is free from electrode film 26,28. The current collector exposed edges 48,50 extend along the long edges of each electrode 16,18, are each characterized as having a width “C” and “D,” respectively. In one embodiment, A≦C≦2,000 μm and B≦D≦3,000 μm. In one subembodiment, A≦C≦400 μm and B≦D≦800 μm.

When each electrode 16,18 is positioned relative to the separator 20 in an offset relationship. When the electrode assembly 12 is wound or rolled-up, the exposed edges 48,50 of each electrode 16,18 project outward beyond the separator or separators 20 at opposing ends of the coiled or wound electrode assembly 12, a distance having a width of C′ and D′, respectively, wherein:
C=C′+A, and
D=D′+B.

Referring to FIGS. 1 and 2, the negative electrode plate 34 contacts the exposed edge 50 of the negative electrode current collector 24 in order to provide electrical communication between the negative electrode current collector 24 and an external load (not illustrated). The opposing positive electrode plate 42 contacts the exposed edge 48 of the positive electrode current collector 26 in order to provide electrical communication between the positive electrode current collector 26 and the external load (not illustrated). A negative electrode plate lead 52 provides electrical contact between negative electrode plate 34 and the cylindrical body member closed end 32. A positive electrode plate lead 54 provides electrical contact between positive electrode plate 42 and the positive electrode assembly 40.

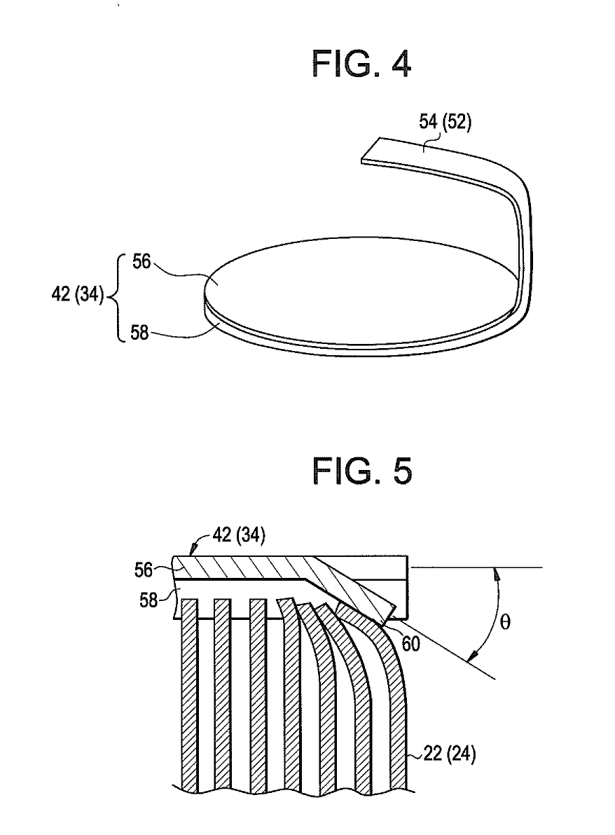

Referring to FIGS. 4 and 5, in one embodiment, one or both electrode plates 34,42 consists of a flat disk-shaped member having substantially the same shape (e.g. same diameter) as the end of the wound electrode assembly 12, having a thickness of between 100 μm and 2,000 μm. In one subembodiment, the electrode plate 34,42 is a single layer material constructed from an electrically conductive material capable of being welded to the relevant battery structure (e.g. the current collector 22,24, positive terminal assembly 40 and/or the cylindrical body member closed end 32). Preferably, the electrode plate 34,42 is constructed from a material that does not form an intermetallic compound with the alkali metal used in the electrolyte (e.g. Li⁺). Examples of such a material include nickel (Ni) and copper (Cu).

In one embodiment, as illustrated in FIG. 4, the electrode plate 34,42 has a two-layer structure, having a first layer 56 and a second layer 58. A two-layer electrode plate 34,42 is best suited for applications where one material does not provide all the desired properties. For example, where laser welding is employed, the layer distal to the electrode assembly 12 (namely, the first layer 56) is selected having a lower beam reflectivity, whereas the layer proximal to the electrode assembly 12 (namely, the second layer 58) exhibits superior resistance to the formation of intermetallic compounds and welding characteristics. In one embodiment, the second layer 58 is a solder or other suitable material which upon heating (e.g. by ultrasonic welding or the like) bonds the electrode plate 34,42 to the current collector 22.

Referring to FIG. 5, in another embodiment, the electrode plate 34,42 is provided with an angled edge 60 along the periphery of the plate 34,42. The angled edge is provided to ensure the outermost current collector exposed edges 48,50 do not contact the inner walls of the cylindrical body member 30.

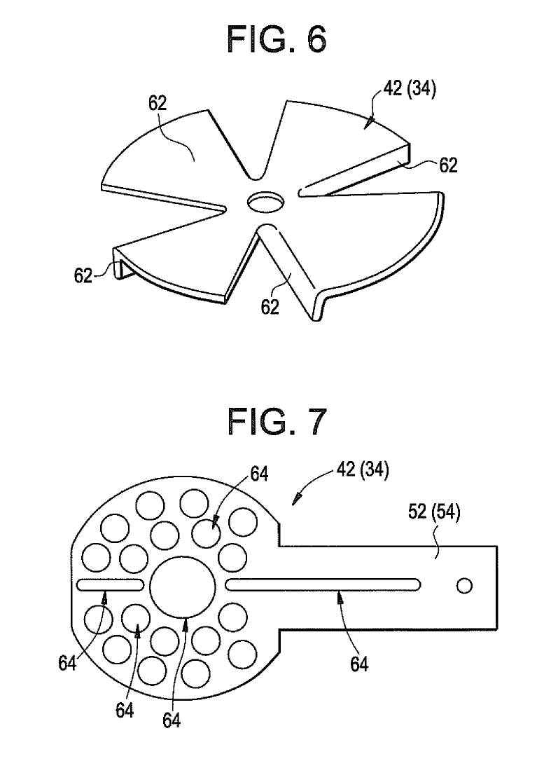

Referring to FIG. 6, in an alternate embodiment, one or both electrode plates 34,42 consists of a flat disks-shaped member having substantially the same shape (e.g. same diameter) as the end of the wound electrode assembly 12, having plurality of bent portions 62 which contact and/or are secured to the corresponding current collector exposed edge 48,50.

Referring to FIG. 7, in an alternate embodiment, one or both electrode plates 34,42 consists of a flat disks-shaped member having substantially the same shape (e.g. same diameter) as the end of the wound electrode assembly 12, having plurality of apertures defined by edge 64 for promoting the free flow of electrolyte in and about the electrode assembly 12

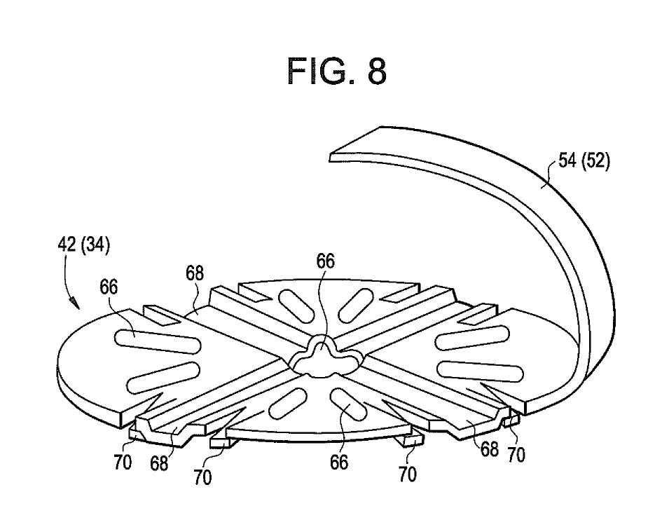

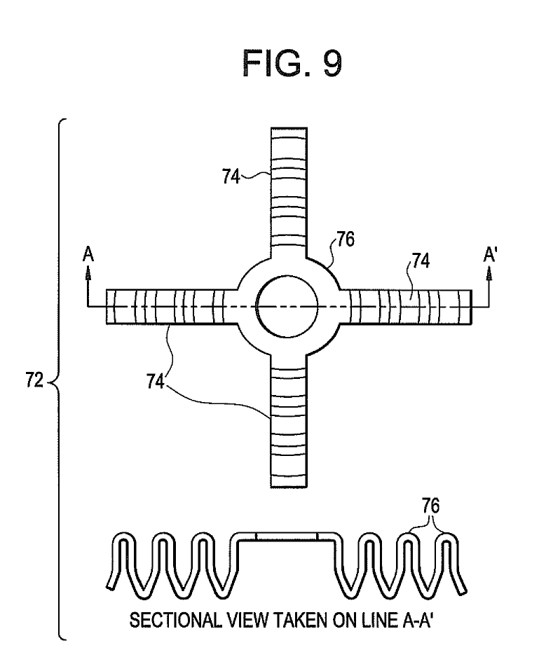

Referring to FIG. 8, in an alternate embodiment, one or both electrode plates 34,42 consists of a flat disks-shaped member having substantially the same shape (e.g. same diameter) as the end of the wound electrode assembly 12, having plurality of apertures defined by edge 66 for promoting the free flow of electrolyte in and about the electrode assembly 12, as well as a plurality of projections 68 that extend toward the electrode assembly 12. Also provided are current collector collection tabs 70 formed by cutting and bending a portion of the outer periphery of the electrode plate 34,42. The current collector collection tabs 70 are provided to ensure the outermost current collector exposed edges 48,50 which are proximal to the projections 68 (and therefore are likely to deform when the electrode plate 34,42 is brought into contact there with) do not contact the inner walls of the cylindrical body member 30.

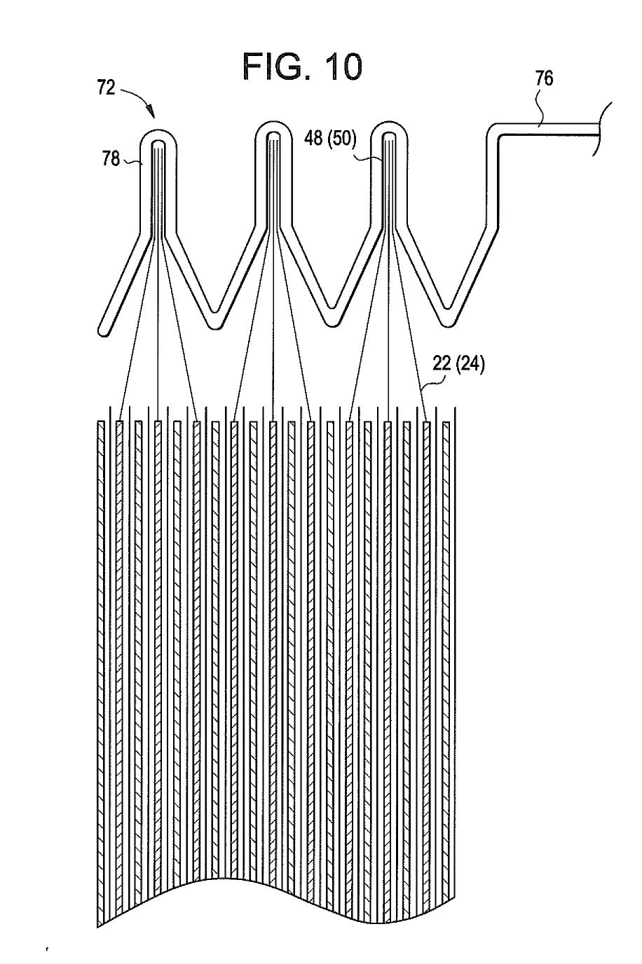

Referring to FIGS. 9 and 10, in an alternate embodiment, a bus member 72 is provided having one or more lengths 74 extending radially from a body member 76. Each length 74 includes one or more U-shaped collection member 78 adapted to receive one or more current collector exposed edges 48,50. In operation, when the current collector exposed edges 48,50 are inserted into a collection member 78, the collection member 78 can either be crimped to secure the current collector exposed edges 48,50 therein, and/or welded.

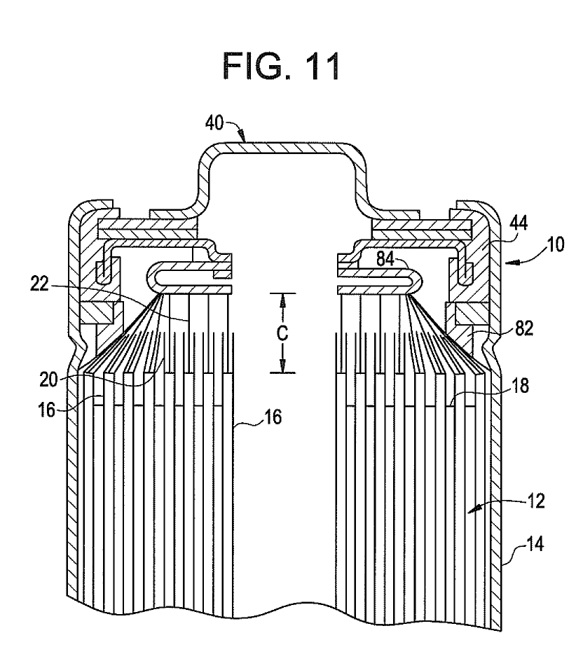

Referring to FIG. 11, in an alternate embodiment, an insulating cone 82 is pressed against the top of the electrode assembly 12 by the gasket member 44 forcing width C of the positive electrode 16 inward. The cone 82 both gathers the exposed edge of the positive electrode current collector 22, as well as prevent the positive electrode current collector 22 from contacting the inner wall of the casing 14. A conductive spring 84 affixed to the positive electrode assembly 40 and biased inward toward the electrode assembly 12 presses down on the top of the electrode assembly 12, contacting the positive electrode current collector 22 which provides electrical communication between the positive electrode 16 and the external load (not illustrated) via the positive terminal subassembly 40. In a subembodiment, the conductive spring 84 is bonded to the positive electrode current collector 22 using laser welding, ultrasonic welding, TIG welding or other similar method. In another subembodiment (not illustrated), a conductive strip having a length approximately twice the width of the electrode assembly 12 is positioned horizontally across the top of the electrode assembly 12 and is bonded to the positive electrode current collector 22 using laser welding, ultrasonic welding, TIG welding or other similar method. The free or non-bonded portion of the strip folds over and is bonded to the positive terminal subassembly 40.

The examples and other embodiments described herein are exemplary and not intended to be limiting in describing the full scope of compositions and methods of this invention. Equivalent changes, modifications and variations of specific embodiments, materials, compositions and methods may be made within the scope of the present invention, with substantially similar results.

What is claimed is:

1. An electrochemical cell, comprising:
a cylindrical casing having an open first end and a closed second end;
a wound electrode assembly positioned in the cylindrical casing, the electrode assembly comprising a separator interposed between a first electrode and a counter second electrode, the separator and first electrode and second electrode each having a top long edge and an opposing bottom long edge;
the first electrode comprising a first electrode film on at least one side of a first electrode current collector, the first electrode current collector having an exposed edge portion free from electrode film and extending along the top long edge of the first electrode, the first electrode current collector exposed edge portion extending beyond the top long edge of the separator; and
the second electrode comprising a second electrode film on at least one side of a second electrode current collector, the second electrode current collector having an exposed edge portion free from electrode film and extending along the bottom long edge of the second electrode, the second electrode current collector exposed edge portion extending beyond the bottom long edge of the separator;
wherein the first and second electrodes are positioned in an offset relationship relative to the separator, the separator extending beyond each of the top and bottom long edges of the first electrode film, and the separator extending beyond each of the top and bottom long edges of the second electrode film;
the electrochemical cell further comprising an electrolyte contained in the cylindrical casing and in ion-transfer communication with the first electrode and the second electrode for transferring ionic charge carriers between the first electrode and the second electrode during charge and discharge of the electrochemical cell;
a first electrode plate in electrical contact with the exposed portion of the first electrode current collector;
a terminal assembly sealingly engaged with the cylindrical casing and in electrical communication with the first electrode plate in order to provide electrical communication between the first electrode current collector and an external load; and
a second electrode plate in electrical contact with the exposed portion of the second electrode current collector and in electrical contact with the cylindrical casing in order to provide electrical communication between the second electrode current collector and the external load;
wherein the first electrode film comprises an electrode active material of the general formula:
AₐM_{m(XY}₄)_{c}Zₑ,
wherein:
(i) A is selected from the group consisting of elements from Group I of the Periodic Table, and mixtures thereof, and 0<a≦9;
(ii) M includes at least one redox active element, and 1≦m≦3;
(iii) XY₄ is selected from the group consisting of X′[O₄₋ₓ,Y′ₓ], X′[O_{4-y}, Y′_{2y}], X″S₄, [X_{z}′″,X′_{1-z}]O₄, and mixtures thereof, wherein:
(a) X′ and X′″ are each independently selected from the group consisting of P, As, Sb, Si, Ge, V, S, and mixtures thereof;
(b) X″ is selected from the group consisting of P, As, Sb, Si, Ge, V, and mixtures thereof;
(c) Y′ is selected from the group consisting of a halogen, S, N, and mixtures thereof; and
(d) 0≦x≦3, 0≦y≦2, 0≦z≦1, and 1<c≦3; and
(iv) Z is selected from the group consisting of a hydroxyl (OH), a halogen selected from Group 17 of the Periodic Table, and mixtures thereof, and 0≦e≦4;
wherein A, M, X, Y, Z, a, m, c, x, y, z, and e are selected so as to maintain electroneutrality of the material in its nascent state.

2. The electrochemical cell of claim 1, wherein the first and second electrode plates each comprise a flat disk-shaped member.

3. The electrochemical cell of claim 2, wherein each electrode plate has an angled edge located about the periphery of the plate.

4. The electrochemical cell of claim 2, wherein each electrode plate comprises a plurality of apertures for promoting the free flow of electrolyte in and about the electrode assembly.

5. The electrochemical cell of claim 4, wherein each electrode plate further comprises a plurality of projections that extend toward the electrode assembly.

6. The electrochemical cell of claim 4, wherein each electrode plate further comprises current collector collection tabs formed by cutting and bending a portion of the outer periphery of each electrode plate.

7. The electrochemical cell of claim 1, wherein the first and second electrode plates each comprise a bus member having one or more lengths extending radially from a body member, each length having one or more U-shaped collection member adapted to receive one or more current corresponding collector exposed edges.

8. The electrochemical cell of claim 1, further comprising an insulating cone pressed against the top of the electrode assembly for gathering the exposed edge portion of the first electrode current collector,
wherein the first electrode plate is a conductive spring operably affixed to the terminal assembly and biased inward toward the electrode assembly.

9. The electrochemical cell of claim 9, wherein the conductive spring is bonded to the exposed edge portion of the first electrode current collector.

10. The electrochemical cell of claim 1, wherein the electrode active material is represented by the general formula:
AₐM_{b}(PO₄)Z_{d},
wherein 0.1≦a≦4, 8≦b≦1.2 and 0≦d≦4, and wherein A, M, Z, a, b , and d are selected so as to maintain electroneutrality of the electrode active material in its nascent state.

11. The electrochemical cell of claim 1, wherein the electrode active material is represented by the general formula:
AM′₁₋ⱼM″ⱼPO₄,
wherein M′ is at least one transition metal from Groups 4 to 11 of the Periodic Table and has a +2 valence state; M″ is at least one metallic element which is from Group 2, 12, or 14 of the Periodic Table and has a +2 valence state, and 0<j<1.

12. The electrochemical cell of claim 1, wherein the electrode active material is represented by the general formula:
LiFe_{1-q}M″_{q}PO₄,
wherein M″ is selected from the group consisting of Mg, Ca, Zn, Sr, Pb, Cd, Sn, Ba, Be, and mixtures thereof; and 0<q<1.

13. The electrochemical cell of claim 1, wherein the electrode active material is represented by the general formula:
AₐCoᵤFeᵥM¹³_{w}M¹⁴ₐₐM¹⁵_{bb}XY₄,
wherein:
(v) 0<a<2
(vi) u>0 and v>0;
(vii) M¹³ is one or more transition metals, wherein w≧0;
(viii) M14 is one or more +2 oxidation state non-transition metals, wherein aa≧0; and
(ix) M¹⁵ is one or more +3 oxidation state non-transition metals, wherein bb≧0;
wherein 0<(u+v+w+aa+bb)<2, and M¹³, M¹⁴, M¹⁵, XY₄, a, u, v, w, aa, bb , x, and y are selected so as to maintain electroneutrality of the electrode active material in its nascent state.

14. The electrochemical cell of claim 1, wherein the electrode active material is represented by the general formula:
A¹ₐ(MO)_{b}M′_{1-b}XO₄,
wherein
(i) A¹ is independently selected from the group consisting of Li, Na, K and mixtures thereof, 0.1<a<2;
(ii) M comprises at least one element, having a +4 oxidation state, which is redox active; 0<b≦1;
(iii) M′ is one or more metals selected from metals having a +2 and a +3 oxidation state; and
(iv) X is selected from the group consisting of P, As, Sb, Si, Ge, V, S, and mixtures thereof.

15. The electrochemical cell of claim 1, wherein the electrode active material is represented by the general formula:
AₐM_{b}(XY₄)₃Z_{d},
wherein 2≦a≦8, 1≦b≦3, and 0≦d≦6.

16. The electrochemical cell of claim 1, wherein the second electrode comprises an intercalation active material selected from the group consisting of transition metal oxides, metal chalcogenides, carbons, and mixtures thereof.

17. The electrochemical cell of claim 16, wherein the intercalation active material is graphite.
